(19) United States
(12) Patent Application Publication
(10) Pub. No.: US 2026/0230381 A1
(43) Pub. Date: Aug. 6, 2026

(54) ARTIFICIAL INTELLIGENCE/MACHINE LEARNING MODEL IDENTIFIER USAGE

(71) Applicant: Nokia Technologies Oy, Espoo (FI)

(72) Inventors: Amaanat ALI, Espoo (FI); Keeth Saliya Jayasinghe LADDU, Espoo (FI); Mihai ENESCU, Espoo (FI); Dimitri GOLD, Espoo (FI)

(21) Appl. No.: 19/148,367

(22) PCT Filed: Jan. 31, 2024
(86) PCT No.: PCT/IB2024/050886

§ 371 Date: Jul. 16, 2025

(30) Foreign Application Priority Data
Feb. 10, 2023 (FI) 20235137

(51) Int. Cl. H04L 41/0823; H04L 41/16

(52) U.S. Cl. CPC H04L 41/0823; H04L 41/16

(57) ABSTRACT

Embodiments of the present disclosure relate to artificial intelligence/machine learning (AI/ML) model identifiers (IDs) usage. A terminal device sends, to a core network device, a request for AI/ML model registration or identification, wherein the request comprises at least one AI/ML model capability of the terminal device. The terminal device receives, from the core network device, a response for the AI/ML model registration or identification, wherein the response comprises an approved or identified list of AI/ML model IDs and at least one AI/ML model delivery preference. The solution for AI/ML model identifiers IDs usage as provided in the present disclosure can provide signaling procedures required to be defined between the terminal device and the network to determine the validity of a given AI/ML model, and allow the network to further query the terminal device of the capabilities pertaining to the AI/ML model(s).

### RELATED APPLICATION

This application claims priority to FI application No. 20235137 filed Feb. 10, 2023, which is incorporated herein by reference in its entirety.

### FIELD

Various example embodiments generally relate to the field of communication, and in particular, to devices, methods, apparatuses and computer readable storage medium for artificial intelligence/machine learning (AI/ML) model identifiers (IDs) usage.

### BACKGROUND

With the development of communication technology, an AI/ML model for new radio (NR) air interface has been studied. In a third generation partnership project (3GPP) Release 18 (Rel-18) study item (SI), it explores benefits of augmenting the air interface with features enabling the support of AI/ML-based algorithms for enhanced performance and/or reduced complexity and overhead.

The initial set of use cases to be covered in Rel-18 SI include CSI feedback enhancement (e.g., overhead reduction, improved accuracy, prediction), beam management (e.g., beam prediction in time, and/or spatial domain for overhead and latency reduction, beam selection accuracy improvement), and positioning accuracy enhancements. Use cases for the AI/ML approaches need to be diverse enough to support various requirements on the next generation node B (gNB)-user equipment (UE) collaboration levels that at least define the combinations of ML models applied at the UE and/or gNB.

### SUMMARY

In general, example embodiments of the present disclosure provide devices, methods, apparatuses and computer readable storage medium for AI/ML model IDs usage. Specifically, the solution can enable provide signaling procedures required to be defined between the terminal device and the network.

In a first aspect, there is provided a terminal device. The terminal device may comprise one or more transceivers; and one or more processors communicatively coupled to the one or more transceivers, and the one or more processors are configured to cause the terminal device to: send, to a core network device, a request for AI/ML model registration or identification, wherein the request comprises at least one AI/ML model capability of the terminal device; and receive, from the core network device, a response for the AI/ML model registration or identification, wherein the response comprises an approved or identified list of AI/ML model IDs and at least one AI/ML model delivery preference.

In a second aspect, there is provided an access network device. The access network device may comprise one or more transceivers; and one or more processors communicatively coupled to the one or more transceivers, and the one or more processors are configured to cause the access network device to: receive, from a core network device, a message comprising a list of approved or identified AI/ML model IDs, and contexts for a terminal device; and store the approved or identified AI/ML model IDs and contexts.

In a third aspect, there is provided a first core network device. The first core network device may comprise one or more transceivers; and one or more processors communicatively coupled to the one or more transceivers, and the one or more processors are configured to cause the first core network device to: receive, from a terminal device, a request for AI/ML model registration or identification, wherein the request comprises at least one AI/ML model capability of the terminal device; determine, based on the at least one AI/ML model capability, a list of AI/ML model IDs, for the terminal device; send, to a second core network device, a request for validating the list of AI/ML model IDs; and receive, from the second core network device, a response comprising a list of approved or identified AI/ML model IDs and contexts.

In a fourth aspect, there is provided a second core network device. The second core network device may comprise one or more transceivers; and one or more processors communicatively coupled to the one or more transceivers, and the one or more processors are configured to cause the second core network device to: receive, from a first core network device, a request for validating a list of AI/ML model IDs associated with a terminal device; determine a list of approved or identified AI/ML model IDs and contexts for the terminal device by validating the list of AI/ML model IDs based on a database of validated AI/ML models for the terminal device; and send, to the first core network device, a response comprising the list of approved or identified AI/ML model IDs and contexts.

In a fifth aspect, there is provided a method implemented at a terminal device. The method may comprise: sending, to a core network device, a request for AI/ML model registration or identification, wherein the request comprises at least one AI/ML model capability of the terminal device; and receiving, from the core network device, a response for the AI/ML model registration or identification comprising an approved or identified list of AI/ML model identifications and at least one AI/ML model delivery preference.

In a sixth aspect, there is provided a method implemented at an access network device. The method may comprise: receiving, from a core network device, a message comprising a list of approved or identified AI/ML model IDs and contexts for a terminal device; and storing the approved or identified AI/ML model IDs and contexts.

In a seventh aspect, there is provided a method implemented at a first core network device. The method may comprise: receiving, from a terminal device, a request for AI/ML model registration or identification, wherein the request comprises at least one AI/ML model capability of the terminal device; determining, based on the at least one AI/ML model capability, a list of AI/ML model IDs for the terminal device; sending, to a second core network device, a request for validating the list of AI/ML model IDs; and receiving, from the second core network device, a response comprising a list of approved or identified AI/ML model IDs and contexts.

In an eight aspect, there is provided a method implemented at a second core network device. The method may comprise: receiving, from a first core network device, a request for validating a list of AI/ML model IDs associated with a terminal device; determine, at the second core network device, a list of approved or identified AI/ML model IDs and contexts for the terminal device by validating the list of AI/ML model IDs based on a database of validated AI/ML models for the terminal device; and sending, to the first core network device, a response comprising the list of approved or identified AI/ML model IDs and contexts.

In a ninth aspect, there is provided an apparatus of a terminal device. The apparatus may comprise: means for sending, to a core network device, a request for AI/ML model registration or identification, wherein the request comprises at least one AI/ML model capability of the terminal device; and means for receiving, from the core network device, a response for the AI/ML model registration or identification comprising an approved or identified list of AI/ML model identifications and at least one AI/ML model delivery preference.

In a tenth aspect, there is provided an apparatus of an access network device. The apparatus may comprise: means for receiving, from a core network device, a message comprising a list of approved or identified AI/ML model IDs and contexts for a terminal device; and means for storing the approved or identified AI/ML model IDs and contexts.

In an eleventh aspect, there is provided an apparatus of a first core network device. The apparatus may comprise: means for receiving, from a terminal device, a request for AI/ML model registration or identification, wherein the request comprises at least one AI/ML model capability of the terminal device; means for determining, based on the at least one AI/ML model capability, a list of AI/ML model IDs for the terminal device; means for sending, to a second core network device, a request for validating the list of AI/ML model IDs; and means for receiving, from the second core network device, a response comprising a list of approved or identified AI/ML model IDs and contexts.

In a twelfth aspect, there is provided an apparatus of a second core network device. The apparatus may comprise: means for receiving, from a first core network device, a request for validating a list of AI/ML model IDs associated with a terminal device; means for determine, at the second core network device, a list of approved or identified AI/ML model IDs and contexts for the terminal device by validating the list of AI/ML model IDs based on a database of validated AI/ML models for the terminal device; and means for sending, to the first core network device, a response comprising the list of approved or identified AI/ML model IDs and contexts.

In a thirteenth aspect, there is provided a non-transitory computer readable medium comprising program instructions for causing an apparatus to perform at least the method according to fifth or eighth aspect.

In a fourteenth aspect, there is provided a computer program comprising instructions, which, when executed by an apparatus, cause the apparatus at least to: send, to a core network device, a request for AI/ML model registration or identification, wherein the request comprises at least one AI/ML model capability of the terminal device; and receive, from the core network device, a response for the AI/ML model registration or identification, wherein the response comprises an approved or identified list of AI/ML model IDs and at least one AI/ML model delivery preference.

In a fifteenth aspect, there is provided a computer program comprising instructions, which, when executed by an apparatus, cause the apparatus at least to: receive, from a core network device, a message comprising a list of approved or identified AI/ML model IDs, and contexts for a terminal device; and store the approved or identified AI/ML model IDs and contexts.

In a sixteenth aspect, there is provided a computer program comprising instructions, which, when executed by an apparatus, cause the apparatus at least to: receive, from a terminal device, a request for AI/ML model registration or identification, wherein the request comprises at least one AI/ML model capability of the terminal device; determine, based on the at least one AI/ML model capability, a list of AI/ML model IDs, for the terminal device; send, to a second core network device, a request for validating the list of AI/ML model IDs; and receive, from the second core network device, a response comprising a list of approved or identified AI/ML model IDs and contexts.

In a seventeenth aspect, there is provided a computer program comprising instructions, which, when executed by an apparatus, cause the apparatus at least to: receive, from a first core network device, a request for validating a list of AI/ML model IDs associated with a terminal device; determine a list of approved or identified AI/ML model IDs and contexts for the terminal device by validating the list of AI/ML model IDs based on a database of validated AI/ML models for the terminal device; and send, to the first core network device, a response comprising the list of approved or identified AI/ML model IDs and contexts.

In an eighteenth aspect, there is provided a terminal device. The terminal device comprises sending circuitry configured to: send, to a core network device, a request for AI/ML model registration or identification, wherein the request comprises at least one AI/ML model capability of the terminal device; and receiving circuitry configured to receive, from the core network device, a response for the AI/ML model registration or identification, wherein the response comprises an approved or identified list of AI/ML model IDs and at least one AI/ML model delivery preference.

In a nineteenth aspect, there is provided an access network device. The network device comprises receiving circuitry configured to: receive, from a core network device, a message comprising a list of approved or identified AI/ML model IDs, and contexts for a terminal device; and storing circuitry configured to: store the approved or identified AI/ML model IDs and contexts.

In a twentieth aspect, there is provided a first core network device. The network device comprises receiving circuitry configured to: receive, from a terminal device, a request for AI/ML model registration or identification, wherein the request comprises at least one AI/ML model capability of the terminal device; determining circuitry configured to: determine, based on the at least one AI/ML model capability, a list of AI/ML model IDs, for the terminal device; sending circuitry configured to: send, to a second core network device, a request for validating the list of AI/ML model IDs; and receiving circuitry configured to: receive, from the second core network device, a response comprising a list of approved or identified AI/ML model IDs and contexts.

In a twenty-first aspect, there is provided a second core network device. The network device comprises receiving circuitry configured to: receive, from a first core network device, a request for validating a list of AI/ML model IDs associated with a terminal device; determining circuitry configured to: determine a list of approved or identified AI/ML model IDs and contexts for the terminal device by validating the list of AI/ML model IDs based on a database of validated AI/ML models for the terminal device; and sending circuitry configured to: send, to the first core network device, a response comprising the list of approved or identified AI/ML model IDs and contexts.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1A illustrates an example network environment in which example embodiments of the present disclosure may be implemented;

FIG. 1B illustrates an AI/ML capability signaling architecture in which example embodiments of the present disclosure may be implemented;

FIG. 2 illustrates an example user equipment capability transfer related to example embodiments of the present disclosure;

FIG. 3 illustrates an example user equipment AI/ML model ID format related to example embodiments of the present disclosure;

FIG. 4 illustrates an example signaling process for AI/ML model identification and capability handling according to some embodiments of the present disclosure;

FIG. 5A illustrates another example signaling process for AI/ML model identification and capability handling according to some embodiments of the present disclosure;

FIG. 5B illustrates yet another example signaling process for AI/ML model identification and capability handling according to some embodiments of the present disclosure;

FIG. 6 illustrates an example flowchart of a method implemented at a terminal device in accordance with some example embodiments of the present disclosure;

FIG. 7 illustrates an example flowchart of a method implemented at an access network device in accordance with some example embodiments of the present disclosure;

FIG. 8 illustrates an example flowchart of a method implemented at a first core network device in accordance with some example embodiments of the present disclosure;

FIG. 9 illustrates an example flowchart of a method implemented at a second core network device in accordance with some example embodiments of the present disclosure;

FIG. 10 illustrates an example simplified block diagram of an apparatus that is suitable for implementing embodiments of the present disclosure; and

FIG. 11 illustrates an example block diagram of an example computer readable medium in accordance with some embodiments of the present disclosure;

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

The terms artificial intelligence and/or machine learning (AI/ML) refer to software-implemented methods based on mathematical algorithms or models providing an inference function. Such models are typically mathematical algorithms, trained with information and that replicate a decision an expert would make when provided that same information. According to some embodiments, AI/ML functions may also provide data analytics. An AI/ML training function associated e.g., with a model takes data, runs the data through the AI/ML model and derives the associated loss and adjusts the parameterization of that AI/ML model based on the computed loss. Training methods may include supervised learning, unsupervised learning and reinforcement learning, and training may be performed offline or be continuous. The inference function can be one of a number of known categories, such as regression-based, clustering- or association based, reward-based behavior, with an appropriate training method being applied.

Example applications of AI and/or ML comprise without limitation: voice recognition; image processing/computer vision; natural language processing; information retrieval; personalization and recommendation; robotics, data analytics including predictive and prescriptive analytics; use-cases for the design and/or planning and/or optimization and/or configuration and/or control and/or management of communication systems and/or networks.

Example use-cases may be without limitation:
use-cases related to the physical-layer of communication networks such as modulation, coding, decoding, signal detection, channel estimation, prediction, compression, interference mitigation;
use-cases related to the medium access control layer of communication networks such as multiple access and resource allocation (e.g., power control, scheduling, spectrum management);
channel modeling;
network optimization;
cell capacity estimation in cellular networks;
routing;
resource management;
data traffic management;
security and anomaly detection;
root cause analysis;
transport protocol design and optimization;
user/network/application behavior analysis/prediction;
transport-layer congestion control;
user experience modeling and optimization;
user mobility and positioning management;
network slicing, network virtualization and software defined networking;
non-linear impairments compensation in optical networks (e.g., visible-light communications, fiber-optics communications, and fiber-wireless converged networks), and
quality-of-transmission estimation and optical performance monitoring in optical networks.

The term AI/ML entity designates any network entity that contains one or more AI and/or ML capabilities. Example network entities comprise without limitation:
radio access network entities such as base stations (e.g., cellular base stations like eNodeB in LTE and LTE-advanced networks and gNodeB used in 5G networks, and femtocells used at homes or at business centers);
relay stations;
control stations (e.g., radio network controllers, base station controllers, network switching sub-systems);
access points in local area networks or ad-hoc networks;
gateways and radio access network entities;
network management entities (e.g., Operation, Administration and Management (OAM) entity);
network automation systems;
distributed analytics entities such as self-autonomous systems (D-SONs);
network functions (e.g., network data analytics function, NWDAF, defined in current 3GPP standards);
user equipment (UE).

The Rel-18 SI's target is to lay the foundation for future air-interface use cases leveraging AI/ML techniques. For AI/ML use cases, the benefits shall be evaluated (utilizing developed methodology and defined KPIs) and potential impact on the specifications shall be assessed including PHY layer aspects, and protocol aspects. One of the expected outcomes of the SI is “The AI/ML approaches for the selected sub-use cases need to be diverse enough to support various requirements on the gNB-UE collaboration levels.”

It is noted that in the work item (WI) phase of “AI/ML for air interface”, additionally other use cases might also be addressed. Starting from Rel-18, a large variety of use cases and applications on AI/ML in the gNB and UE are proposed. The goal is to explore the benefits of augmenting the air-interface with features enabling improved support of AI/ML-based algorithms for enhanced performance and/or reduced complexity/overhead. The enhanced performance here depends on the considered use cases and could be, e.g., improved throughput, robustness, accuracy or reliability, etc. The goal is that sufficient use cases will be considered to enable the identification of a common AI/ML framework, including functional requirements of AI/ML architecture, which could be used in subsequent projects. The study should also identify areas where AI/ML could improve the performance of air-interface functions. Specification impact will be assessed in order to improve the overall understanding of what would be required to enable AI/ML techniques for the air interface.

From the discussions in RAN1/RAN2 that a UE supporting ML model for augmenting a given functionality in the specification (e.g., beam management, CSI reporting) will use a AI/ML model ID (may also referred as ML Model ID) to identify which ML model corresponding to the functionality that is being used (e.g., CSI compression, CSI prediction, time domain beam prediction, spatial domain beam prediction, ML based positioning are all underlying functionalities). However, it is not clear that how the network is supposed to know/identify which particular AI/ML model ID's are valid. Validity here could imply many things, such as the underlying ML model is in force, can be used by the UE, tested, validated, authenticated, authorized for usage, is ready to be configured for a UE, etc. This is even more important as the network is unable to comprehend what is behind a ML model (often this is a deep neural network and a network cannot be expected to comprehend the architectural and implementation aspects as often this is a choice of machine learning implementation and typically has hundreds of different options and variants to choose from and details are often private and cannot be exposed).

It is neither clear that once the network can reliably determine “valid” AI/ML model ID's, how the capabilities corresponding to these are retrieved from the UE so that the UE can be configured to take these into account. Furthermore, how can the network enable transferring the ML model architecture representation (this may be encoded in a set of OCTETS using well-known tools e.g., see ONNX format) to the UE is also unanswered.

It may be envisaged that there are signaling procedures required to be defined between the UE and the network to determine the validity of a given ML model and allow the network to further query the UE of the capabilities pertaining to these ML model(s). The following aspects are required to resolve the above issues:

The present application defines novel procedures for: 1) ML model storage in newly defined network logical nodes; 2) AI/ML model ID(s) validation and activation at the UE and gNB; 3) UE capability model enquiry and configuration (which can also be achieved via model functionality enquiry and configuration).

Therefore, the present disclosure proposed an AI/ML model identification and capability handling for UE(s). According to embodiments of the present disclosure, a terminal device sends, to a core network device, a request for AI/ML model registration or identification. The request comprises at least one AI/ML model capability of the terminal device. The terminal device receives, from the core network device, a response for the AI/ML model registration or identification. The response comprises an approved or identified list of AI/ML model IDs.

It is understood that the above procedure steps may work together, in a flow of operations as described in the next section, partly together or independently of each other.

The solution for AI/ML model IDs usage as provided in the present disclosure can provide signaling procedures required to be defined between the terminal device and the network to determine the validity of a given AI/ML model, and allow the network to further query the terminal device of the capabilities pertaining to the AI/ML model(s). Principles and some example embodiments of the present disclosure will be described in detail below with reference to the accompanying drawings.

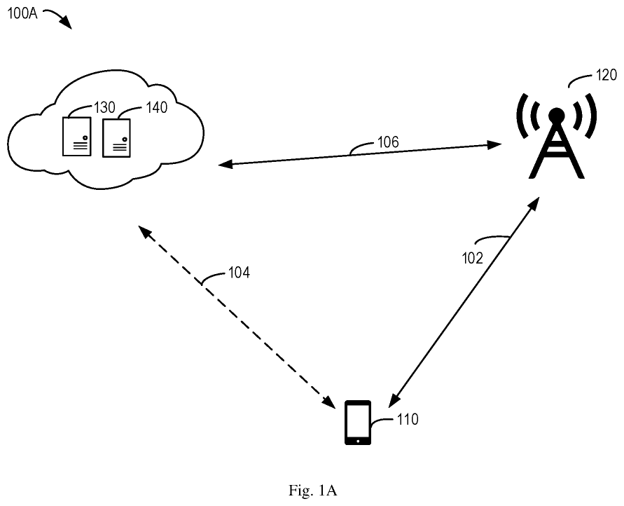

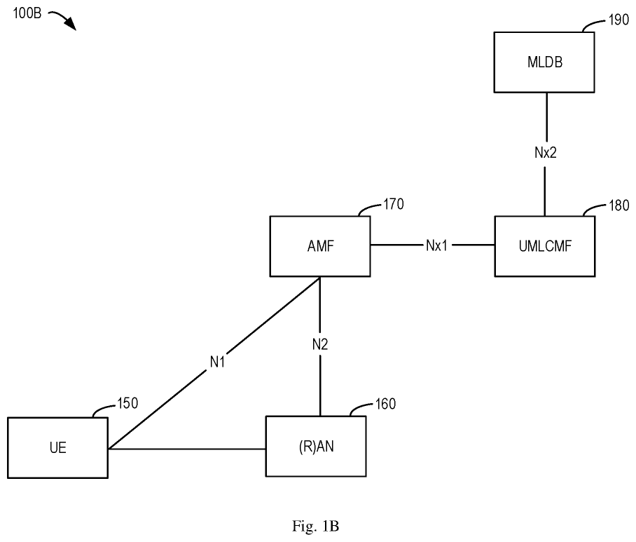

For illustrative purposes, principle and example embodiments of the present disclosure for the PHR operation will be described below with reference to FIG. 1A-FIG. 11. However, it is to be noted that these embodiments are given to enable the skilled in the art to understand inventive concepts of the present disclosure and implement the solution as proposed herein, and not intended to limit scope of the present application in any way.

Reference is made to FIG. 1A, which illustrates an example network environment 100A in which example embodiments of the present disclosure may be implemented. The network environment 100A, which may be a part of a communication network, includes a terminal device 110, an access network device 120, a first core network device 130 and a second core network device 140.

As illustrated in FIG. 1A, the terminal device 110 may also be referred as a user equipment 110 or a UE 110. The access network device 120 may also be referred as a gNB 120. The first core network device 130 may also be referred as an access and mobility management function (AMF) 130. The second core network device 140 may also be referred as a user equipment machine learning capability management function (UMLCMF) 140. In some embodiments, AMF 130 and UMLCMF 140 are logical entities. Therefore, it is possible to combine AMF 130 and UMLCMF 140 together or implement the role of UMLCMF 140 into AMF 130.

In some embodiments, UMLCMF 140 may be required to store all the AI/ML model ID(s) with the corresponding AI/ML model context. The context, for example, may include meta-data that indicates high-level details of a model (such as architecture, number of layers) and applicable radio, configuration, and parameter conditions under which the model has been trained).

In some embodiments, UMLCMF 140 may include AI/ML model data. For example, the AI/ML model data may include the model container that holds the data corresponding to the given ML model.

Reference is made to FIG. 1B, which illustrates an AI/ML capability signaling architecture in which example embodiments of the present disclosure may be implemented. The network environment 100B, which may be a part of a communication network, includes a UE 150, a radio access network (RAN) 160, an AMF 170, a UMLCMF 180 and a machine learning database (MLDB) 190.

As illustrated in FIG. 1B, UE 150 may correspond to the terminal device 110. RAN 160 may correspond to the access network device 120. AMF 170 may correspond to the first core network device 130. UMLCMF 180 may correspond to the second core network device 140.

In some embodiments, MLDB 190 may be a ML external third party database or a ML external operator database. AI/ML models may be stored in MLDB 190. An operator may push an AI/ML model to UMLCMF 180. The stored AI/ML model contents and contexts may be visualized as a string of octets ranging from a few 100 KB to several hundreds of MB depending on the kind of ML model pertaining to the UE(s) for different manufacturers and different versions and functions. The UMLCMF 180 may use an interface to link itself to the MLDB 190, and whereby the operator has control on which AI/ML model ID(s) are considered to be valid to be taken into use in the given network. N×1 refers to Service-based interface exhibited by UMLCMF 180. N×2 refers to Service-based interface exhibited by MLDB 190.

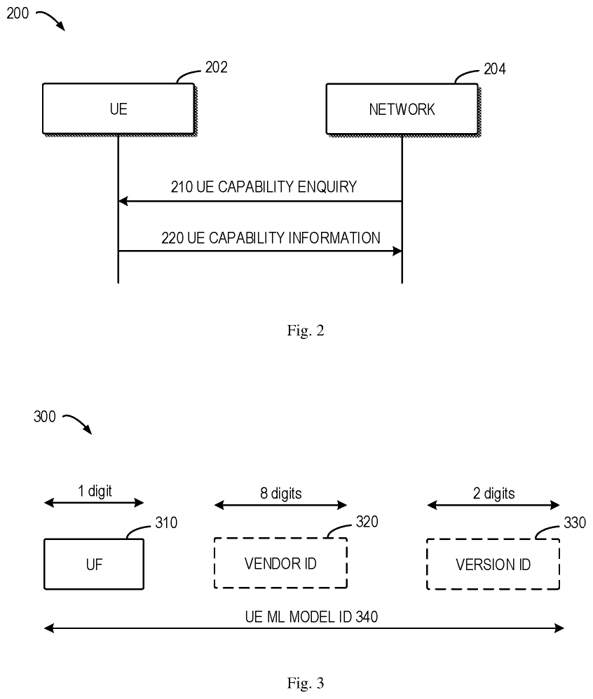

Reference is made to FIG. 2, which illustrates an example user equipment capability transfer 200 related to example embodiments of the present disclosure. FIG. 2 describes how a UE compiles and transfers its UE capability information upon receiving a UECapabilityEnquiry from the network. The network 204 may initiate the procedure to a UE 202 in RRC_CONNECTED when it needs UE radio access capability information, or when it needs additional UE radio access capability information. The network 204 may retrieve UE capabilities after access stratum (AS) security activation. The network 204 may not forward UE capabilities that were retrieved before AS security activation to the CN.

Table 1 shows some terminologies that may be used in the present disclosure.

TABLE 1

| Terminology | Description |
|---|---|
| Data collection | A process of collecting data by the network nodes, |
| | management entity, or UE for the purpose of AI/ML |
| | model training, data analytics and inference |
| AI/ML Model | A data driven algorithm that applies AI/ML |
| | techniques to generate a set of outputs based on a set |
| | of inputs. |
| AI/ML model training | A process to train an AI/ML Model [by learning the |
| | input/output relationship] in a data driven manner and |
| | obtain the trained AI/ML Model for inference |
| AI/ML model Inference | A process of using a trained AI/ML model to produce |
| | a set of outputs based on a set of inputs |
| AI/ML model validation | A subprocess of training, to evaluate the quality of an |
| | AI/ML model using a dataset different from one used |
| | for model training, that helps selecting model |
| | parameters that generalize beyond the dataset used |
| | for model training. |
| AI/ML model testing | A subprocess of training, to evaluate the performance |
| | of a final AI/ML model using a dataset different from |
| | one used for model training and validation. |
| | Differently from AI/ML model validation, testing |
| | does not assume subsequent tuning of the model. |
| UE-side (AI/ML) model | An AI/ML Model whose inference is performed |
| | entirely at the UE |
| Network-side (AI/ML) model | An AI/ML Model whose inference is performed |
| | entirely at the network |
| One-sided (AI/ML) model | A UE-side (AI/ML) model or a Network-side |
| | (AI/ML) model |
| Two-sided (AI/ML) model | A paired AI/ML Model(s) over which joint inference |
| | is performed, where joint inference comprises AI/ML |
| | Inference whose inference is performed jointly across |
| | the UE and the network, i.e, the first part of inference |
| | is firstly performed by UE and then the remaining |
| | part is performed by gNB, or vice versa. |
| AI/ML model transfer | Delivery of an AI/ML model over the air interface, |
| | either parameters of a model structure known at the |
| | receiving end or a new model with parameters. |
| | Delivery may contain a full model or a partial model. |
| Model download | Model transfer from the network to UE |
| Model upload | Model transfer from UE to the network |
| Federated learning / | A machine learning technique that trains an AI/ML |
| federated training | model across multiple decentralized edge nodes (e.g., |
| | UEs, gNBs) each performing local model training |
| | using local data samples. The technique requires |
| | multiple interactions of the model, but no exchange |
| | of local data samples. |
| Offline field data | The data collected from field and used for offline |
| | training of the AI/ML model |
| Online field data | The data collected from field and used for online |
| | training of the AI/ML model |
| Model monitoring | A procedure that monitors the inference performance |
| | of the AI/ML model |
| Supervised learning | A process of training a model from input and its |
| | corresponding labels. |
| Unsupervised learning | A process of training a model without labelled data. |
| Semi-supervised learning | A process of training a model with a mix of labelled |
| | data and unlabelled data |
| Reinforcement Learning (RL) | A process of training an AI/ML model from input |
| | (a.k.a. state) and a feedback signal (a.k.a. reward) |
| | resulting from the model's output (a.k.a. action) in an |
| | environment the model is interacting with. |
| Model activation | enable an AI/ML model for a specific function |
| Model deactivation | disable an AI/ML model for a specific function |
| Model switching | Deactivating a currently active AI/ML model and |
| | activating a different AI/ML model for a specific |
| | function |

Table 2 shows a working assumption, which considering “proprietary model” and “open-format model” as two separate model format categories for RAN1 discussion.

TABLE 2

| | |
|---|---|
| Proprietary-format models | ML models of vendor-/device-specific proprietary format, |
| | from 3GPP perspective |
| | NOTE: An example is a device-specific binary executable |
| | format |
| Open-format models | ML models of specified format that are mutually |
| | recognizable across vendors and allow interoperability, |
| | from 3GPP perspective |

From RAN1 discussion viewpoint, RAN1 may assume that: 1) Proprietary-format models are not mutually recognizable across vendors, hide model design information from other vendors when shared; and 2) Open-format models are mutually recognizable between vendors, do not hide model design information from other vendors when shared.

Table 3 shows another working assumption, which explains two terminologies which may be used herein.

TABLE 3

| Terminology | Description |
|---|---|
| Model identification | A process/method of identifying an AI/ML model for the |
| | common understanding between the NW and the UE |
| | Note: The process/method of model identification may or |
| | may not be applicable. |
| | Note: Information regarding the AI/ML model may be |
| | shared during model identification. |
| Functionality identification | A process/method of identifying an AI/ML functionality |
| | for the common understanding between the NW and the |
| | UE |
| | Note: Information regarding the AI/ML functionality may |
| | be shared during functionality identification. |
| | FFS: granularity of functionality |

In RAN2 meetings, there are some agreements. TABLE 4 shows initial assumption that was made in the previous RAN2 #119-bis-e meeting.

TABLE 4
Organizational:
RAN2's work can be somewhat split: A) use-case-centric configuration,
signalling and control procedures, B) management of data and AI/ML models
(where part of discussion may overlap between use cases).
Assume that e.g. for the management of data and AI/ML models, RAN2 could
start by focusing on data collection, model transfer, model update, model
monitoring and model selection/(de)activation/switching/fallback (to the
extent needed), whether UE capabilities has a role in this.
AIML methods:
RAN2 will reuse terminology defined by RAN1 to the extent
possible/reasonable
For the existing AI/ML use cases discussed in RAN1, proprietary models may
be supported and/or open format may be supported.
From Management or Control point of view mainly some meta info about a
model may need to be known, details FFS.
A model is identified by a model ID. Its usage is FFS.
General FFS: AIML Model delivery to the UE may have different options,
Control-plane (multiple subvariants), User Plane, can be discussed case by
case.

Table 5 shows initial assumption that was made in the previous RAN2 #120 meeting.

TABLE 5
AI/ML methods:
R2 assumes that model ID can be used to identify which AI/ML model is
being used in LCM including model delivery.
R2 assumes that model ID can be used to identify a model (or models) during
model selection/activation/deactivation/switching (can later align with R1 if
needed).
It is allowed to discuss/determine that functionality can be done outside 3GPP
system scope, i.e. OTT server. NO agreement for now on the specifics due to
long discussion.
Proposal (modified) Requirements for Data collection should include data
collection for model updates / offline training, and non-real-time monitoring
(for decision to retrain etc)
For model transfer/delivery for AI/ML models (for the target use cases of this
SI), RAN2 to study CP-based, UP-based solutions

Reference is made to FIG. 3, which illustrates an example user equipment AI/ML model ID format 300 related to example embodiments of the present disclosure. As shown in FIG. 3, there are three fields. UF 310 means that use case specific information which tells about the functionality of the ML model (e.g., beam management, CSI compression, positioning, mobility enhancement, power saving, etc.). The length of UF 310 may be one hexadecimal digit.

Vendor ID 320 may be another field. The Vendor ID 320 may be an identifier of UE manufacturer. This is defined by a value of Private Enterprise Number issued by Internet Assigned Numbers Authority (IANA) in its capacity as the private enterprise number administrator, as maintained at https://www.iana.org/assignments/enterprise-numbers/enterprise-numbers. The length of Vendor ID 320 may be eight hexadecimal digits. Version ID 330 means that the current version ID configured in the UMLCMF 180. The length of Version ID 330 may be two hexadecimal digits.

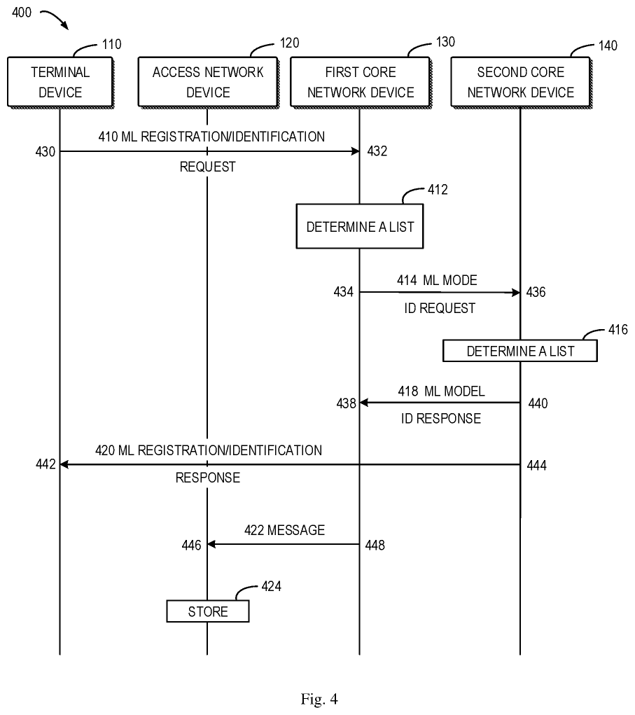

Reference is made to FIG. 4, which illustrates an example signaling process 400 for AI/ML model identification and capability handling according to some embodiments of the present disclosure. As shown, a terminal device 110 sends (430), to a first core network device 130, a request 410 for AI/ML model registration or identification. The request 410 comprises at least one AI/ML model capability of the terminal device 110.

The first core network device 130 receives (432) the request 410. Then, the first core network device 130 determines (412), based on the at least one AI/ML model capability, a list of AI/ML model IDs for the terminal device 110. The first network device 130 sends (434), to a second core network device 140, a request 414 for validating the list of AI/ML model ID. The second core network device 140 receives (436), from the first core network device 130, the request 414.

The second core network device 140 determines (416) a list of approved or identified AI/ML model IDs and contexts for the terminal device by validating the list of AI/ML model IDs based on a database of validated AI/ML models for the terminal device. The second core network device 140 sends (440), to the first core network device 130, a response 418 comprising the list of approved or identified AI/ML model IDs and contexts. The first core network device 130 receives (438), from the second core network device 140, the response 418.

The second core network device 140 sends (444), to the terminal device 110, a response 420 for the AI/ML model registration or identification. The response 420 comprises an approved or identified list of AI/ML model IDs and at least one AI/ML model delivery preference. The terminal device 110 receives (442) the response 420.

The first core network device 130 sends (448), to the access network device 120, a message 422 comprising a list of approved or identified AI/ML model IDs, and contexts for a terminal device. The access network device 120, receives (446), from the first core network device 130, the message 422. The access network device 120, stores (424) the approved or identified AI/ML model IDs and contexts.

By implementing FIG. 4, AI/ML model IDs usage can be provided. As such, signaling procedures can be defined between the terminal device and the network to determine the validity of a given AI/ML model, and can allow the network to further query the terminal device of the capabilities pertaining to the AI/ML model(s).

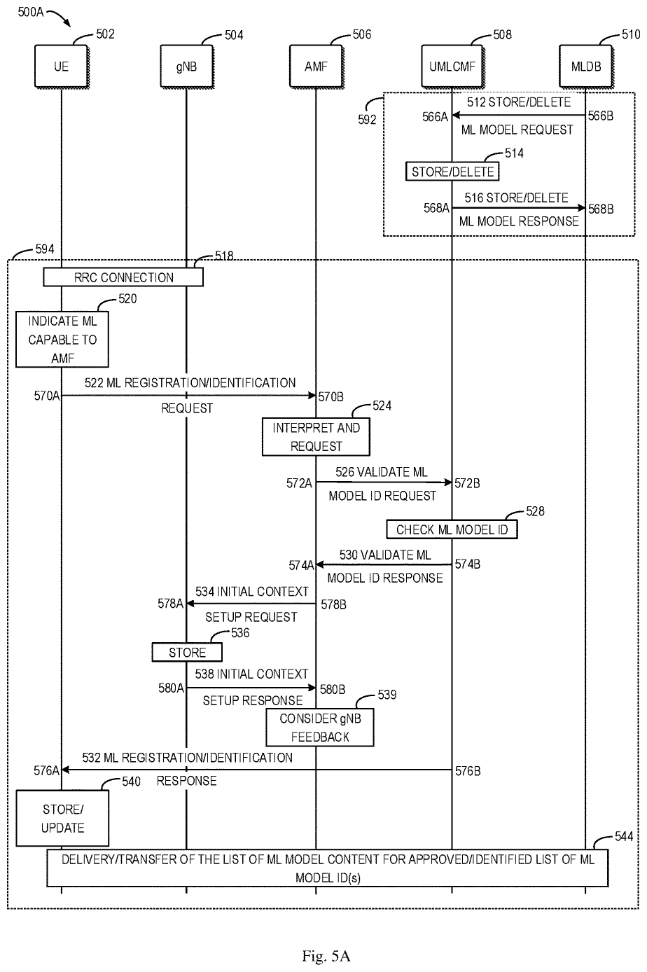

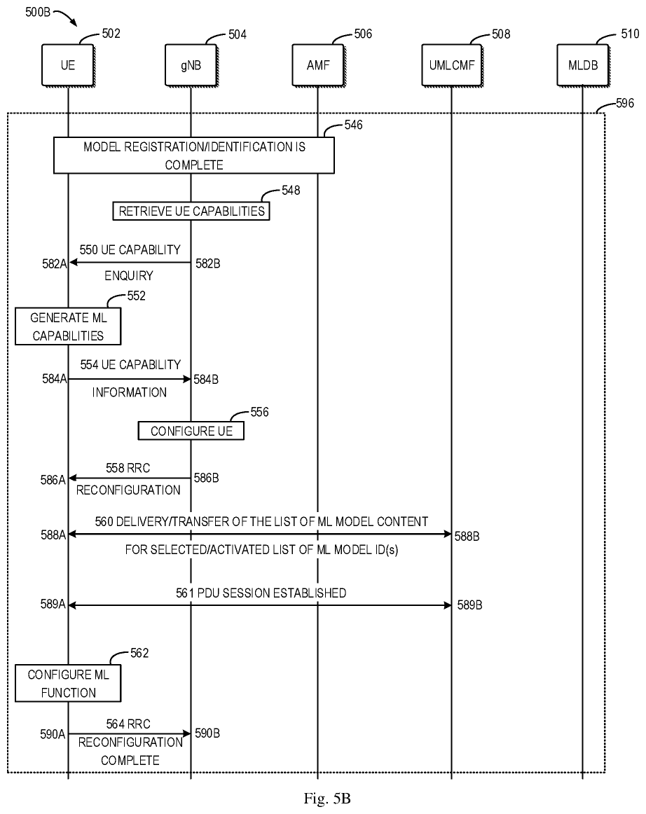

Reference is made to FIG. 5A, which illustrates another example signaling process 500A for AI/ML model identification and capability handling according to some embodiments of the present disclosure. It is understood that the example signaling process 500A in FIG. 5A can be considered as an example of the signaling process 400 in FIG. 4. Accordingly, the UE 502 in FIG. 5A is an example of the terminal device 110 in FIG. 4. The gNB 504 in FIG. 5A is an example of the access network device 120 in FIG. 4. The AMF 506 in FIG. 5A is an example of the first core network device 130 in FIG. 4. The UMLCMF 508 in FIG. 5A is an example of the second core network device 140 in FIG. 4. FIG. 5A discusses two scenarios. Scenario 1 discusses how AI/ML models are stored by the network entity. Scenario 2 discusses UE-specific AI/ML model registration/identification.

Scenario 1 is shown in dashed box 592. At 566B, MLDB 510 may send a store/delete AI/ML model request 512 to UMLCMF 508. At 566A, UMLCMF 508 may receive the request 512. At 514, the UMLCMF 508 may store or delete the AI/ML model according to the request 512. At 568A, the UMLCMF 508 may send a store/delete AI/ML model response 516 to MLDB 510.

In some embodiments, The UMLCMF 508 may receive a request for AI/ML models from an entity that maintains a database of validated ML models. The database may store the UE-sided models or the UE part of the two-sided models which may be trained offline (offline model updates may also be a possibility), and each of the trained models may be referred to by an AI/ML model ID with the corresponding ML model context and ML model data. Herein, AI/ML model data (may also be referred to ML-Model-Content) may be optionally sent to the UMLCMF 508. The UMLCMF 508 may store the received list of AI/ML model IDs, ML-Model-context, and ML-Model-Content. A response/confirmation of successful model reception may be sent from UMLCMF 508 to MLDB 510.

In some embodiments, for the CSI compression use case, network and UE vendors may develop multiple two-sided ML models considering different deployment environments, parameters, and configurations. Those models may be stored in the operator database, where the controllability of the used models in the air interface is guaranteed. Prior to the use of any of these models for CSI compression, the network entity UMLCMF may get the latest set of models (at least the UE-sided part of the two-sided model) from the operator-controlled dataset using steps discussed above in dashed box 592.

Scenario 2 is shown in dashed box 594. The purpose of scenario 2 is to enable the network to ensure that a set of given AI/ML model ID(s) are activated to the UE and also known to the gNB. At 518, UE 502 may have a RRC connection 518 to gNB 504. At 520, UE 502 may start the IMSI (International mobile subscriber identity) attach/registration procedure which is performed as a result of UE power on or mobility across different tracking areas within a PLMN.

At 570A, UE 502 may send AI/ML registration/identification request 522 to AMF 506. At 570B, AMF 506 may receive the request 522. In some embodiments, During the IMSI attach procedure, UE 502 may send an ML model registration request (or can also refer to an ML model identification request) to the AMF 506, where ML model capabilities may be declared by the UE 502. The ML model capabilities may be generic capabilities for example known at the Non-Access Stratum layer which allows the AMF to determine what kind of ML capabilities the UE might already be pre-programmed with e.g., availability of a hardware accelerator or GPU, amount of RAM for ML purpose.

In some embodiments, the request 522 may also contain a list of stored/supported AI/ML model IDs by the UE, where the list of AI/ML model IDs that the device supports or uses by default (i.e., factory programmed from manufacturer). In some embodiments, the list of AI/ML model IDs may be a request to update the latest list of AI/ML model IDs that were previously identified/registered with the network. In some embodiments, the UE 502 may indicate a ML model delivery (content and context) preference to the network. This will be discussed in 544.

At 524, the AMF 506 may determine, based on the at least one AI/ML model capability, a list of AI/ML model IDs for the terminal device 502. At 572A, the AMF 506 may send a validating AI/ML model ID request 526 to the UMLCMF 508. At 572B, the UMLCMF 508 may receive the request 526 from the AMF 506. At 528, the UMLCMF 508 may check the AI/ML model IDs.

In some embodiments, the AMF 506 may forward the list of AI/ML model ID(s) from the UE 502 to the UMLCMF 508 which may return a response list of allowed AI/ML model ID(s) and the ML model context and content. The AMF 506 may otherwise interpret the ML capabilities and may be able to determine from the AI/ML model ID(s) that some of these AI/ML model ID(s) may not be suitable e.g., because an operator has prohibited their usage in the PLMN or a zone within the PLMN and may filter the list towards the UMLCMF.

In some embodiments, the UMLCMF 508 may be provided the ML capabilities and may perform the filtering based on interpreting the ML capabilities. The difference between ML content and context is that the ML content is the list of OCTETS that contains the actual ML model parameters but the context contains the meta-data to interpret the ML content (e.g., input/output format, number of layers, etc.). This kind of separation of ML content and context is understood to be the norm of specifying an ML model.

At 574B, the UMLCMF 508 may send a validating AI/ML model ID response 530 to the AMF 506. At 574A, the AMF 506 may receive the response 530 to from the UMLCMF 508. At 578B, the AMF 506 may send an initial context setup request 534 to a gNB 504. At 578A, the gNB 504 may receive the request 534. At 536, the gNB 504 may store the approved or identified AI/ML model IDs and contexts.

At 580A, the gNB 504 may send an initial context setup response 538 to the AMF 506. At 580B, the AMF may receive the response 538. In some embodiments, the gNB 504 may be updated with the list of approved/identified AI/ML model ID(s) and the ML Model Content and Content for each of the AI/ML model ID(s). In some embodiments, the gNB 504 may provide feedback to AMF on the approved/identified list of ML model ID(s) by checking the ML Model Context (e.g., by checking historical performance data for a set of visited cells).

In some embodiments, there is an acknowledgement for each AI/ML model ID, which is the “ML model delivery preference” ACKed by the network. This will allow some ML model IDs to be directly delivered to UE via OTT (over the air) and some of them via the network.

At 539, AMF 506 may consider feedback from gNB 504. In some embodiments, gNB 504 may send feedback to AMF 506 on the approved/identified list of ML model ID(s) by checking the ML Model Context. In some embodiments, the gNB 504 may also check the model context and determine suitability (e.g., by checking the performance information in the ML model context). If suitable (i.e., better than a reference threshold say 90%) checks with model context the gNB 504 can proceed further with transfer to UE 503. If not then the gNB 504 can tell AMF that the ML Model ID cannot be taken into use and then AMF 506 can tag it unsuitable. In some embodiments, an operator can then decide to remove this model from a database.

At 576B, the UMLCMF 508 may send a ML registration/identification response 532 to the UE 502. At 576A, the UE 502 may receive the response 532. In some embodiments, the UE 503 may receive the ML model registration response (or can also refer to an ML model identification response) from the AMF 506, where an approved or updated list of AI/ML model IDs is known to the UE 502. Herein, the UE 502 may be expected to use the approved/identified/updated list of AI/ML models.

In some embodiments, the response 532 may also contain an updated list for the UE indicated stored/supported AI/ML model IDs, where the updates may also consider replacing the use of an older version of an ML model with a new one.

In some embodiments, the response 532 may comprise the ML model delivery preference for each approved/identified ML Model ID. This can allow the network to acknowledge or update the request from UE 502 at 522.

In some embodiments, for the CSI compression use case, the UE 502 may send ML model capabilities and supported AI/ML model IDs for two-sided ML models in 570A for the model identification, where the ML model capabilities may also indicate supporting other types of models. Based on 524 to 530, the AMF 506 may realize other ML models are more suited for the network and UE 502 than the models supported by the UE 502. If an identified UE 502 part of the two-sided model is still within the supported ML capabilities of the UE 502, such a model may be included in the updated list of AI/ML model IDs.

At 540, the UE 502 may store or update the approved, identified or updated list of AI/ML model IDs. In some embodiments, as an additional step, at 544, in the case of model delivery being supported as a part of model registration/identification, the network may initiate model delivery for the approved or updated list of AI/ML model IDs. The model delivery preference is indicated by the UE 502 at 570A which is either accepted by the AMF 506 or overridden by AMF 506 to decide a ML model delivery method towards the UE 502. In some embodiments, the UE 502 may request the ML model delivery to be performed by direct communication with a 3^{rd} party server. In this case the 3GPP network is transparent to the ML model delivery process (however, for the ML model delivery though a separate data/PDU session may have to be established between the UE and the 3^{rd} party server).

In some embodiments, the UE 502 may indicate a preference that the 3GPP network would intervene and then either the ML model delivery (i.e., content and context) are both transferred between AMF 506 and UE 502 or AMF 506 may request gNB 504 to perform the ML model delivery. In some embodiments, the model delivery procedure may be initiated by the UE 502 when certain models in the approved or updated list of AI/ML model IDs are not available at the UE 502.

As such, at the end of scenario 2, the UE 502 and network are fully in sync with what AI/ML model ID(s) the UE 502 is authorized to use in the network.

Reference is made to FIG. 5B, which illustrates yet another example signaling process 500B for AI/ML model identification and capability handling according to some embodiments of the present disclosure. It is understood that the example signaling process 500B in FIG. 5B can be considered as an example of the signaling process 400 in FIG. 4. Accordingly, the UE 502 in FIG. 5B is an example of the terminal device 110 in FIG. 4. The gNB 504 in FIG. 5B is an example of the access network device 120 in FIG. 4. The AMF 506 in FIG. 5B is an example of the first core network device 130 in FIG. 4. The UMLCMF 508 in FIG. 5B is an example of the second core network device 140 in FIG. 4. FIG. 5B discusses scenario 3. Scenario 3 is shown in dashed box 596. Scenario 3 discusses UE model delivery, capability enquiry and configuration of ML model.

At 546, model registration/identification may be complete. In some embodiments, prior to any UE capability enquiry and reporting, the models used by the UE 502 may go through the model registration/identification (i.e., Scenario 1 and/or 2) procedure.

At 548, the gNB 520 may retrieve UE capabilities for approved/identified list of model IDs. In some embodiments, the retrieving may comprise 550, 552 and 554. At 582B, the gNB 504 may send a UE capability enquiry 550 to the UE 502. At 582A, the UE 502 may receive the enquiry 550. At 552, the UE 502 may generate AI/ML capabilities according to the enquiry 550. At 584A, the UE 502 may send UE capability information 554 to the gNB 504.

In some embodiments, the gNB 504 may wish to retrieve the ML model capabilities of the UE 502 and hence the gNB 504 may format and send a UE capability enquiry 550 towards the UE 502. Based on the UE capability enquiry 550, the UE 502 may generate UE capability reporting, where reporting may assume the approved/registered AI/ML model IDs stored as a result of the earlier procedure discussed above. Then, the UE capability is reported towards the gNB 504.

In some embodiments, the UE capability reporting of ML capabilities may be done by reporting Model-functionalities (Model-functionality may define the associated radio control parameter capabilities (often defined by the specification) when supporting an ML feature or ML use case).

In some embodiments, within a given Model-functionality, more than one AI/ML model IDs may be supported by the UE, where these AI/ML model IDs for a given Model-functionality may also be included in the capability report. Here, different AI/ML model IDs can still refer to different ML-Model-Contexts and ML-Model-Contents, which are identified before by the network and still be used when configuring a UE with ML configuration. In some embodiments, Model-functionality may also be identified by an ID (refer as Model-functionality-ID).

At 556, the gNB 504 may configure the UE 502 based on the UE capability information 554. In some embodiments, the configuring may comprise 558, 562 and 564. Based on the received UE capability information 554, the gNB 504 may configure the UE 502 with an ML use case/feature. In some embodiments, if more than one AI/ML model ID is supported for a given Model-functionality, the gNB may send an activation or selection command to the UE to indicate the exact AI/ML model ID that shall be used for the ML use case/feature.

In some embodiments, for the CSI compression use case, the UE 502 may support transformer-based NN architecture in one AI/ML model ID and non-transformer-based NN architecture in another AI/ML model ID for a given Model-functionality. If the network wishes to apply transformer-based NN architecture (at the decoder/gNB part of the two-sided model) at the gNB 504, an additional selection command may be sent by the gNB 504 to select the AI/ML model ID that uses transformer-based NN architecture.

In some embodiments, as an additional step, at 560, in the case of model delivery being supported as a part of the model configuration (to avoid a large number of model deliveries, which may be the case for 544), the network may initiate model delivery for the configured/selected/activated list of AI/ML model IDs.

At 589A and 589B, a PDU session 561 may be started. The AMF 506 may establish the PDU session 561 to transfer the AI/ML model content to the UE 502. This is the case when the core network is involved in the model delivery.

At 562, the UE 502 may configure ML functionality according to the configuration/selection/activation received by the gNB 504. At 590A, the UE 502 may send RRC reconfiguration complete message 564 to the gNB 504. At 590B, the gNB 504 may receive the message 564.

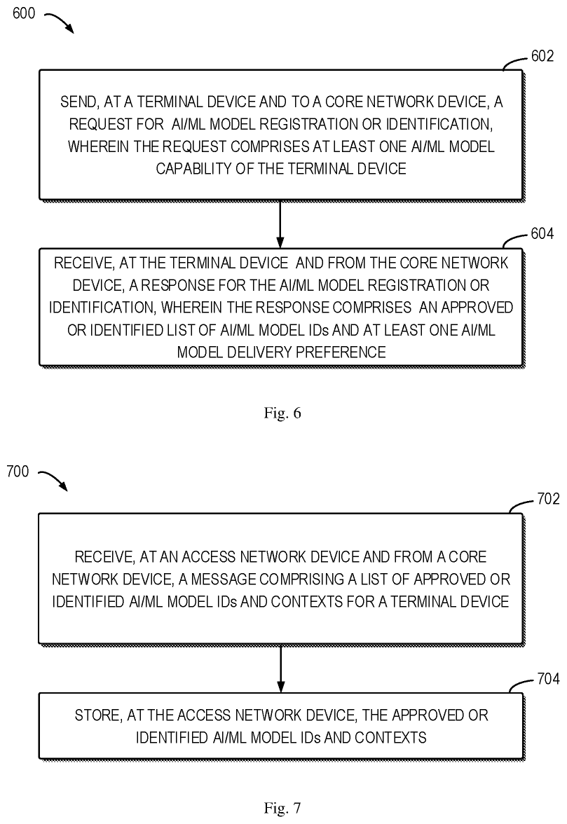

Reference is made to FIG. 6, which illustrates an example flowchart 600 of a method implemented at a terminal device in accordance with some example embodiments of the present disclosure. Reference will be made in combination with FIG. 1A.

At 602, the terminal device 110 sends, to a core network device 130, a request for AI/ML model registration or identification. The request comprises at least one AI/ML model capability of the terminal device. At 604, the terminal device 110 receives, from the core network device 130, a response for the AI/ML model registration or identification. The response comprises an approved or identified list of AI/ML model IDs and at least one AI/ML model delivery preference.

In some embodiments, the terminal device 110 may store the approved or identified list of AI/ML model IDs. In some embodiments, the terminal device 110 may update a previous list of AI/ML model IDs stored at the terminal device based on the approved or identified list of AI/ML model IDs.

In some embodiments, the terminal device 110 may receive, from at least one of an access network device 120, the core network device 130 or a third party database, a list of AI/ML model contents for the approved or identified list of AI/ML model IDs.

In some embodiments, the terminal device 110 may receive, from an access network device 130, a capability enquiry for retrieving at least one capability for the approved or identified AI/ML model IDs. The terminal device 110 may generate, based on the capability enquiry, a capability report comprising at least one capability for the approved or identified AI/ML model IDs. The terminal device 110 may send the capability report to the access network device 120.

In some embodiments, the terminal device 110 may receive, from an access network device 130, a reconfiguration message. The reconfiguration message is generated based on at least one capability of the terminal device 110 for at least one AI/ML Model ID, and the reconfiguration message comprises at least one configuration specific to the approved or identified AI/ML model IDs. In some embodiments, the terminal device 110 may configure at least one AI/ML model functionality based on the received reconfiguration message. In some embodiments, the terminal device 110 may send a reconfiguration complete message to the access network device 120.

In some embodiments, the terminal device 110 may receive, from at least of the core network device 130, the third party device or an operator, a list of AI/ML model contents for a configured, selected, or activated list of AI/ML model IDs. In some embodiments, the request for AI/ML model registration or identification may further comprise a list of stored or supported AI/ML mode IDs at the terminal device 110.

Reference is made to FIG. 7, which illustrates an example flowchart 700 of a method implemented at an access network device in accordance with some example embodiments of the present disclosure. Reference will be made in combination with FIG. 1A.

At 702, the access network device 120 receives, from a core network device 130, a message comprising a list of approved or identified AI/ML model IDs and contexts for a terminal device 110. At 704, the access network device 130 stores the approved or identified AI/ML model IDs and contexts.

In some embodiments, the access network device 120 may assess or validate the approved or identified AI/ML model IDs based on the AI/ML model contexts. The access network device 120 may send, to the terminal device 110, a list of AI/ML model contents for the approved or identified list of AI/ML model IDs.

In some embodiments, the access network device 120 may determine AI/ML capabilities of the terminal device 110 for the approved or identified AI/ML model IDs. The access network device 120 may send a capability enquiry of the terminal device 110. The capability enquiry comprises the AI/ML capabilities.

In some embodiments, the access network device 120 may send, to the terminal device 110, a capability enquiry for retrieving at least one capability for the approved or identified AI/ML model IDs. The access network device 120 may receive, from the terminal device 110, a capability report comprising at least one capability for the approved or identified AI/ML model IDs.

In some embodiments, the access network device 120 may send, to the terminal device 110, a reconfiguration message comprising at least one configuration specific to the approved or identified AI/ML model IDs. The access network device 120 may receive a reconfiguration complete message from the terminal device 110.

In some embodiments, the message may further comprise a list of AI/ML model contents for the approved or identified list of AI/ML model IDs.

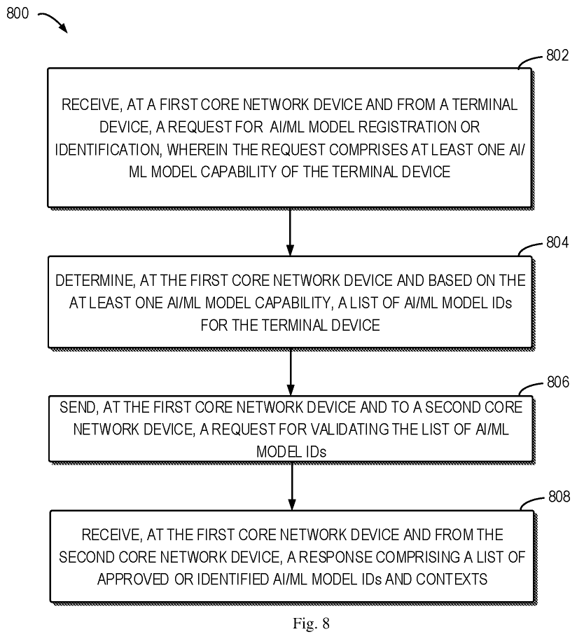

Reference is made to FIG. 8, which illustrates an example flowchart 800 of a method implemented at a first core network device in accordance with some example embodiments of the present disclosure. Reference will be made in combination with FIG. 1A.

At 802, the first core network device 130 receives, from a terminal device 110, a request for AI/ML model registration or identification. The request comprises at least one AI/ML model capability of the terminal device. At 804, the first core network device 130 determines, based on the at least one AI/ML model capability, a list of AI/ML model IDs for the terminal device 110. At 806, the first core network device 130 sends, to a second core network device 140, a request for validating the list of AI/ML model IDs. At 808, the first core network device 130 receives, from the second core network device, a response comprising a list of approved or identified AI/ML model IDs and contexts.

In some embodiments, the first core network device 130 may send, to the terminal device 110, a response for the AI/ML model registration or identification. The response comprises a list of approved or identified AI/ML model IDs and at least one AI/ML model delivery preference.

In some embodiments, the first core network device 130 may send, to an access network device 120, a message comprising the list of approved or identified AI/ML model IDs and contexts for the terminal device 110. In some embodiments, the first core network device 130 may send, to the terminal device 110, a list of AI/ML model contents for the approved or identified list of AI/ML model IDs.

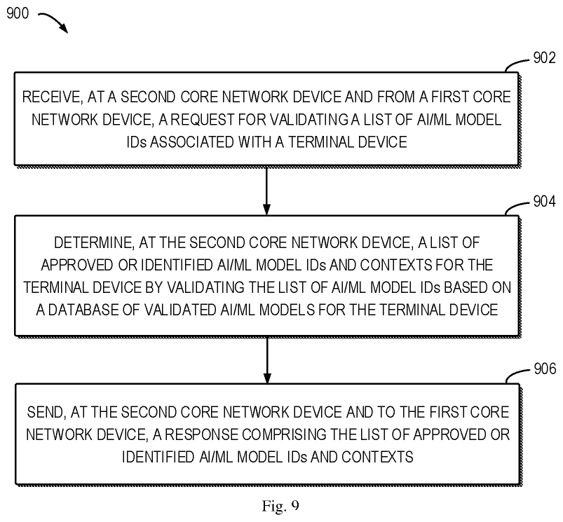

Reference is made to FIG. 9, which illustrates an example flowchart 900 of a method implemented at a second core network device in accordance with some example embodiments of the present disclosure. Reference will be made in combination with FIG. 1A.

At 902, the second core network device 140 receives, from a first core network device 130, a request for validating a list of AI/ML model IDs associated with a terminal device 110. At 904, the second core network device 140 determines a list of approved or identified AI/ML model IDs and contexts for the terminal device 110 by validating the list of AI/ML model IDs based on a database of validated AI/ML models for the terminal device 110. At 906, the second core network device 140 sends, to the first core network device 130, a response comprising the list of approved or identified AI/ML model IDs and contexts.

In some embodiments, the second core network device 140 may receive, from the database, a request for storing or deleting an AI/ML model. The request comprises a model ID and a model context of the AI/ML model. In some embodiments, the second core network device 140 may store or delete the AI/ML model based on the request. In some embodiments, the second core network device 140 may send, to the database, a response to the request. In some embodiments, the request may further comprise a model content of the AI/ML model.

By implementing the methods 600, 700, 800 and 900, the solution for AI/ML model IDs usage can provide signaling procedures required to be defined between the terminal device and the network to determine the validity of a given AI/ML model, and allow the network to further query the terminal device of the capabilities pertaining to the AI/ML model(s).

In some example embodiments, an apparatus capable of performing the method 600 may comprise means for performing the respective steps of the method 600. The means may be implemented in any suitable form. For example, the means may be implemented in a circuitry or software module.

In some example embodiments, the apparatus comprises means for sending, to a core network device, a request for AI/ML model registration or identification, wherein the request comprises at least one AI/ML model capability of the terminal device; and means for receiving, from the core network device, a response for the AI/ML model registration or identification, wherein the response comprises an approved or identified list of AI/ML model IDs and at least one AI/ML model delivery preference.

In some example embodiments, the apparatus may comprise means for storing the approved or identified list of AI/ML model IDs; and means for updating a previous list of AI/ML model IDs stored at the terminal device based on the approved or identified list of AI/ML model IDs.

In some example embodiments, the apparatus may comprise means for receiving, from at least one of an access network device, the core network device or a third party device, a list of AI/ML model contents for the approved or identified list of AI/ML model IDs.

In some example embodiments, the apparatus may comprise means for receiving, from an access network device, a capability enquiry for retrieving at least one capability for the approved or identified AI/ML model ID; means for generating, based on the capability enquiry, a capability report comprising at least one capability for the approved or identified AI/ML model IDs; and means for sending the capability report to the access network device.

In some example embodiments, the apparatus may comprise means for receiving, from an access network device, a reconfiguration message, wherein the reconfiguration message is generated based on at least one capability of the terminal device for at least one AI/ML Model ID, and the reconfiguration message comprises at least one configuration specific to the approved or identified AI/ML model IDs; means for configuring at least one AI/ML model functionality based on the received reconfiguration message; and means for sending a reconfiguration complete message to the access network device.

In some example embodiments, the apparatus may comprise means for receiving, from at least one of the core network device, the third party device or an operator, a list of AI/ML model contents for a configured, selected, or activated list of AI/ML model IDs.

In some example embodiments, the request for AI/ML model registration or identification further comprises a list of stored or supported AI/ML mode IDs at the terminal device.

In some embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some example embodiments, an apparatus capable of performing the method 700 may comprise means for performing the respective steps of the method 700. The means may be implemented in any suitable form. For example, the means may be implemented in a circuitry or software module.

In some example embodiments, the apparatus comprise means for receiving, from a core network device, a message comprising a list of approved or identified AI/ML model IDs and contexts for a terminal device; and means for storing the approved or identified AI/ML model IDs and contexts.

In some example embodiments, the apparatus may comprise means for assessing or validating the approved or identified AI/ML model IDs based on the AI/ML model contexts; and means for sending, to the terminal device, a list of AI/ML model contents for the approved or identified list of AI/ML model IDs.

In some example embodiments, the apparatus may comprise means for determining AI/ML capabilities of the terminal device for the approved or identified AI/ML model IDs; and means for sending a capability enquiry of the terminal device, wherein the capability enquiry comprises the AI/ML capabilities.

In some example embodiments, the apparatus may comprise means for sending, to the terminal device, a capability enquiry for retrieving at least one capability for the approved or identified AI/ML model IDs; and means for receiving, from the terminal device, a capability report comprising at least one capability for the approved or identified AI/ML model IDs.

In some example embodiments, the apparatus may comprise means for sending, to the terminal device, a capability enquiry for retrieving at least one capability for the approved or identified AI/ML model IDs; and means for receiving, from the terminal device, a capability report comprising at least one capability for the approved or identified AI/ML model IDs.

In some example embodiments, the apparatus may comprise means for sending, to the terminal device, a reconfiguration message comprising at least one configuration specific to the approved or identified AI/ML model IDs; and means for receiving a reconfiguration complete message from the terminal device. In some example embodiments, the message may further comprise a list of AI/ML model contents for the approved or identified list of AI/ML model IDs.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some example embodiments, an apparatus capable of performing the method 800 may comprise means for performing the respective steps of the method 800. The means may be implemented in any suitable form. For example, the means may be implemented in a circuitry or software module.

The apparatus may comprise means for receiving, from a terminal device, a request for AI/ML model registration or identification, wherein the request comprises at least one AI/ML model capability of the terminal device; means for determining, based on the at least one AI/ML model capability, a list of AI/ML model IDs for the terminal device; means for sending, to a second core network device, a request for validating the list of AI/ML model IDs; and means for receiving, from the second core network device, a response comprising a list of approved or identified AI/ML model IDs and contexts.

In some example embodiments, the apparatus may comprise means for sending, to the terminal device, a response for the AI/ML model registration or identification, wherein the response comprises a list of approved or identified AI/ML model IDs and at least one AI/ML model delivery preference. In some example embodiments, the apparatus may comprise means for sending, to an access network device, a message comprising the list of approved or identified AI/ML model IDs and contexts for the terminal device.

In some example embodiments, the apparatus may comprise means for sending, to the terminal device, a list of AI/ML model contents for the approved or identified list of AI/ML model IDs.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

In some example embodiments, an apparatus capable of performing the method 900 may comprise means for performing the respective steps of the method 900. The means may be implemented in any suitable form. For example, the means may be implemented in a circuitry or software module.

The apparatus may comprise means for receiving, from a first core network device, a request for validating a list of AI/ML model IDs associated with a terminal device; means for determine, at the second core network device, a list of approved or identified AI/ML model IDs and contexts for the terminal device by validating the list of AI/ML model IDs based on a database of validated AI/ML models for the terminal device; and means for sending, to the first core network device, a response comprising the list of approved or identified AI/ML model IDs and contexts.

In some example embodiments, the apparatus may comprise means for receiving, from the database, a request for storing or deleting an AI/ML model, wherein the request comprises a model ID and a model context of the AI/ML model; means for storing or delete the AI/ML model based on the request; and means for sending, to the database, a response to the request. In some example embodiments, the request may further comprise a model content of the AI/ML model.

In some embodiments, the apparatus further comprises means for performing other steps in some embodiments of the method 900. In some embodiments, the means comprises at least one processor and at least one memory including computer program code, the at least one memory and computer program code configured to, with the at least one processor, cause the performance of the apparatus.

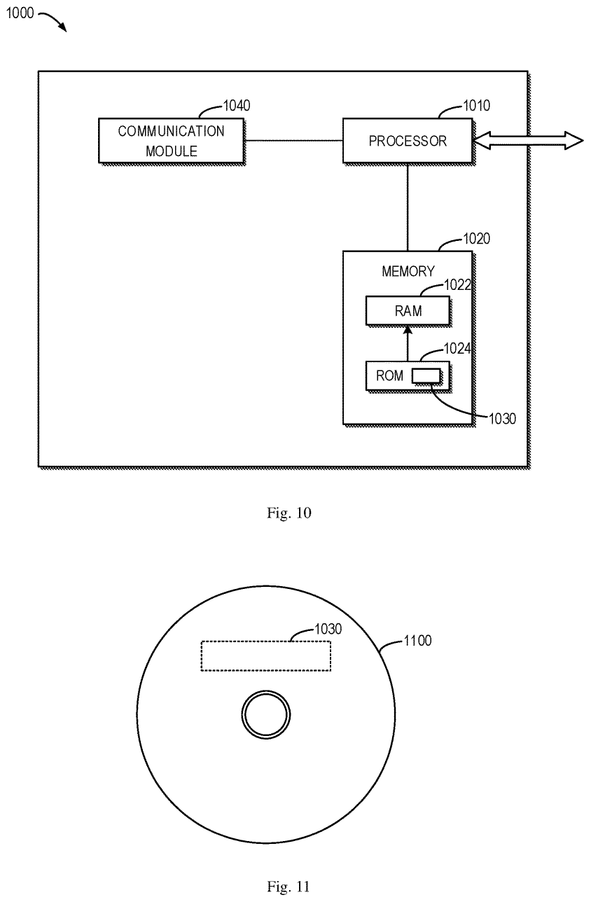

Reference is made to FIG. 10, which illustrates an example simplified block diagram of an apparatus that is suitable for implementing embodiments of the present disclosure. The device 1000 may be provided to implement the communication device, for example the terminal device 110 as shown in FIG. 1A. As shown, the device 1000 includes one or more processors 1010, one or more memories 1040 may couple to the processor 1010, and one or more communication modules 1040 may couple to the processor 1010.

The communication module 1040 is for bidirectional communications. The communication module 1040 has at least one antenna to facilitate communication. The communication interface may represent any interface that is necessary for communication with other network elements, for example the communication interface may be wireless or wireline to other network elements, or software based interface for communication.

The processor 1010 may be of any type suitable to the local technical network and may include one or more of the following: general purpose computers, special purpose computers, microprocessors, digital signal processors (DSPs) and processors based on multicore processor architecture, as non-limiting examples. The device 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a read only memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program so that the device 1000 may perform any process of the disclosure as discussed with reference to FIG. 4 to FIG. 9. The embodiments of the present disclosure may also be implemented by hardware or by a combination of software and hardware.

In some embodiments, the program 1030 may be tangibly contained in a computer readable medium which may be included in the device 1000 (such as in the memory 1020) or other storage devices that are accessible by the device 1000. The device 1000 may load the program 1030 from the computer readable medium to the RAM 1022 for execution. The computer readable medium may include any types of tangible non-volatile storage, such as ROM, EPROM, a flash memory, a hard disk, CD, DVD, and the like. FIG. 11 shows an example of the computer readable medium 1100 in form of CD or DVD. The computer readable medium has the program 1030 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 600, 700, 800 or 900 as described above with reference to FIG. 6 or FIG. 9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-25. (canceled)

26. A terminal device comprising:
at least one processor; and
at least one memory storing instructions that, when executed by the at least one processor, cause the terminal device at least to:
send, to a core network device, a request for artificial intelligence/machine learning (AI/ML) model registration or identification, wherein the request comprises at least one AI/ML model capability of the terminal device; and
receive, from the core network device, a response for the AI/ML model registration or identification, wherein the response comprises an approved or identified list of AI/ML model identifiers (IDs) and at least one AI/ML model delivery preference.

27. The terminal device of claim 26, wherein the terminal device is further caused to:
store the approved or identified list of AI/ML model IDs; or
update a previous list of AI/ML model IDs stored at the terminal device based on the approved or identified list of AI/ML model IDs.

28. The terminal device of claim 26, wherein the terminal device is further caused to:
receive, from at least one of an access network device, the core network device or a third party device, a list of AI/ML model contents for the approved or identified list of AI/ML model IDs.

29. The terminal device of claim 26, wherein the terminal device is further caused to:
receive, from an access network device, a capability enquiry for retrieving at least one capability for the approved or identified AI/ML model IDs;
generate, based on the capability enquiry, a capability report comprising at least one capability for the approved or identified AI/ML model IDs; and
send the capability report to the access network device.

30. The terminal device of claim 26, wherein the terminal device is further caused to:
receive, from an access network device, a reconfiguration message, wherein the reconfiguration message is generated based on at least one capability of the terminal device for at least one AI/ML Model ID, and the reconfiguration message comprises at least one configuration specific to the approved or identified AI/ML model IDs;
configure at least one AI/ML model functionality based on the received reconfiguration message; and
send a reconfiguration complete message to the access network device.

31. The terminal device of claim 26, wherein the terminal device is further caused to:
receive, from at least one of the core network device, a third party device or an operator, a list of AI/ML model contents for a configured, selected, or activated list of AI/ML model IDs.

32. The terminal device of claim 26, wherein:
the request for AI/ML model registration or identification further comprises a list of stored or supported AI/ML mode IDs at the terminal device.

33. An access network device comprising:
at least one processor; and
at least one memory storing instructions that, when executed by the at least one processor, cause the access network device at least to:
receive, from a core network device, a message comprising a list of approved or identified artificial intelligence/machine learning (AI/ML) model identifiers (IDs) and contexts for a terminal device; and
store the approved or identified AI/ML model IDs and contexts.

34. The access network device of claim 33, wherein the access network device is further caused to:
assess or validate the approved or identified AI/ML model IDs based on the AI/ML model contexts; and
send, to the terminal device, a list of AI/ML model contents for the approved or identified list of AI/ML model IDs.

35. The access network device of claim 33, wherein the access network device is further caused to:
determine AI/ML capabilities of the terminal device for the approved or identified AI/ML model IDs; and
send a capability enquiry of the terminal device, wherein the capability enquiry comprises the AI/ML capabilities.

36. The access network device of claim 33, wherein the access network device is further caused to:
send, to the terminal device, a capability enquiry for retrieving at least one capability for the approved or identified AI/ML model IDs; and
receive, from the terminal device, a capability report comprising at least one capability for the approved or identified AI/ML model IDs.

37. The access network device of claim 33, wherein the access network device is further caused to:
send, to the terminal device, a reconfiguration message comprising at least one configuration specific to the approved or identified AI/ML model IDs; and
receive a reconfiguration complete message from the terminal device.

38. The access network device of claim 33, wherein the message further comprises a list of AI/ML model contents for the approved or identified list of AI/ML model IDs.

39. A first core network device comprising:
at least one processor; and
at least one memory storing instructions that, when executed by the at least one processor, cause the first core network device at least to:
receive, from a terminal device, a request for artificial intelligence/machine learning (AI/ML) model registration or identification, wherein the request comprises at least one AI/ML model capability of the terminal device;
determine, based on the at least one AI/ML model capability, a list of AI/ML model identifiers (IDs) for the terminal device; and
send, to the terminal device, a response for the AI/ML model registration or identification, wherein the response comprises a list of approved or identified AI/ML model IDs and at least one AI/ML model delivery preference.

40. The first core network device of claim 39, wherein the first core network device is further caused to:
send, to a second core network device, a request for validating the list of AI/ML model IDs; and receive, from the second core network device, a response comprising a list of approved or identified AI/ML model IDs and contexts.

41. The first core network device of claim 39, wherein the first core network device is further caused to:
send, to an access network device, a message comprising the list of approved or identified AI/ML model identifiers, IDs, and contexts for the terminal device.

42. The first core network device of claim 39, wherein the first core network device is further caused to:
send, to the terminal device, a list of AI/ML model contents for the approved or identified list of AI/ML model IDs.
